(19) United States
(12) Patent Application Publication
(10) Pub. No.: US 2005/0055245 A1
(43) Pub. Date: Mar. 10, 2005

(54) Hospital and clinic emergency preparedness optimization system

(76) Inventors: Neill S. Oster, Oceanside, NY (US); Mary W. Chaffee, Montgomery Village, MD (US)

Correspondence Address: GIBBONS, DEL DEO, DOLAN, GRIFFINGER & VECCHIONE, 1 RIVERFRONT PLAZA, NEWARK, NJ, 07102-5497, US

(21) Appl. No.: 10/934,686

(22) Filed: Sep. 3, 2004

Related U.S. Application Data
(60) Provisional application No. 60/500,233, filed on Sep. 5, 2003.

(51) Int. Cl. G06F 17/60

(52) U.S. Cl. 705/2

(57) ABSTRACT

A method for analyzing medical facility's emergency preparedness that includes determining whether the medical facility has at least one procedure used in the event of an emergency; if so, developing a strategy for improvement of the at least one procedure; in response to the determining and developing, providing a self-assessment tool to the medical facility for completion by the medical facility's personnel, wherein the self-assessment tool is based on a plurality of factors relating to various aspects of the medical facility and addresses at least one area of the medical facility's emergency preparedness; reviewing the self-assessment tool after completion from the medical facility's personnel and reviewing the at least one procedure; evaluating the medical facility and the medical facility's personnel based on the reviewing; and suggesting recommendations for the improvement of the at least one procedure based on the evaluating.

### CROSS REFERENCE TO RELATED APPLICATIONS

The present application claims priority to the U.S. Provisional Patent Application No. 60/500,233, filed Sep. 4, 2003, to Oster, titled “Hospital and Clinic Emergency Preparedness Optimization System” and its subject matter is incorporated herein by reference in its entirety.

### FIELD OF THE INVENTION

The present invention generally relates to a field of management of medical facilities. Specifically, the present invention relates to hospital and ambulatory clinic emergency management systems.

While natural disaster and disease outbreaks have historically produced large numbers of patients requiring intensive hospital and clinic services in a short period of time, the threat of an intentional terrorist act has increased the need for hospitals to have an optimized emergency preparedness system. This can be achieved through a standardized expert analysis using a validated tool and the development of an expert-guided action plan to remediate vulnerabilities. Without such preparedness, the operation of hospitals and clinics may become stressed to the point of failure.

The purpose of the emergency management planning in hospitals and clinics is to ensure that the organization establishes, maintains, and revises a plan to effectively respond to any emergency situation or disaster. Emergency situations and disasters include:
Natural disaster (hurricane, tornado, tsunami, flood, earthquake, and others);
Terrorism (chemical, biological, radiological, nuclear, and high-yield explosive);
Man-made/industrial/transportation; and
Acts of war.

Optimal emergency planning in health care agencies will improve the quality and efficiency of heath care services provided by the hospitals and clinics to the largest number of emergency patients in the shortest period of time.

A hospital is a health care organization that provides medical, nursing and other services to ill and injured patients 24 hours a day, seven days a week as well as preventive service to maintain wellness. As shown in FIG. 3, hospitals have a governing body, an organized professional staff, and in-patient care facilities. Hospitals are depended upon by the individuals in their communities and regions to provide a wide variety of health services, including preventative, restorative and emergency services, as shown in FIG. 3. A hospital itself may be the site of a disaster or casualty-producing situation and in order to provide care, it must have effective emergency response plans in place.

Ambulatory care clinics (hereinafter, “clinics”) provide health services to patients who are not confined to a bed during the time the services are provided. Ambulatory care services are provided in a wide variety of settings and locations. Clinics are depended upon in many communities to provide certain level of emergency and disaster response, though at a level of care less than that of a hospital. As shown in FIG. 4, clinics operate in a manner similar to that of the hospitals.

Because hospitals and clinics are complex organizations functioning within generally strict resource limits, emergency planning must be practical and efficient. It also must be based on current best practices. An optimization of emergency management planning and response requires expert data collection, analysis, synthesis and interpretation for the data to be used in a meaningful corrective action plan. Thus, there is a need for a system that will allow a medical facility, such as a hospital or an ambulatory clinic, to keep current on and improve its emergency preparedness planning and procedures.

### SUMMARY OF THE INVENTION

The present invention relates to a system and a method for improving medical facility's. emergency preparedness procedures. In an embodiment, the present invention relates to a method for analyzing medical facility's emergency preparedness. The method is designed to determine whether the medical facility has at least one emergency procedure or a response plan. If so, a strategy is developed for improvement of that procedure. Then, a preliminary analysis of the medical facility and the procedure is conducted. After that, a self-assessment tool is provided to the medical facility for completion by the medical facility's personnel. The self-assessment tool is developed based on a plurality of factors relating to various aspects of the medical facility and addresses medical facility's emergency preparedness. The completed self-assessment tool received from the medical facility's personnel and the current emergency procedure or response plan are then reviewed. After a review of the completed self-assessment tool, the medical facility and the medical facility's personnel are evaluated. At the end, various recommendations for the improvement of the procedure or response plan are suggested.

In an alternate embodiment, the present invention relates to a system for analyzing medical facility's emergency preparedness. The system includes a medical facility's emergency preparedness sub-system, unit or an organizational structure, which responds to an emergency based on the emergency preparedness procedure. The system also includes a strategic development unit configured to improve the at least one emergency preparedness procedure. The unit is configured to conduct a preliminary analysis of the medical facility and the emergency preparedness procedure. The system further includes a self-assessment tool configured to assist the strategic development unit in analyzing the medical facility. The self-assessment tool is completed by the medical facility's personnel. It is developed based on a plurality of factors relating to operations and regulations of the medical facility. Further, the tool addresses various areas of the medical facility's emergency preparedness. The strategic development unit reviews and evaluates the self-assessment tool after completion by the medical facility's personnel and the emergency preparedness procedure.

In yet an alternate embodiment, the present invention is a product useful to evaluate emergency preparedness of a facility. More specifically, the product is an analysis tool for ambulatory care having queries to prompt responses with respect to facility profile, critical preparedness and facility readiness.

In yet another alternate embodiment, the present invention is an analysis tool for hospitals, where the tool includes queries prompting responses with respect to facility's profile, critical preparedness and facility readiness.

Further features and advantages of the invention, as well as structure and operation of various embodiments of the invention, are disclosed in detail below with references to the accompanying drawings.

### BRIEF DESCRIPTION OF THE FIGURES

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 is a flow chart diagram illustrating a method for analyzing medical facility's emergency preparedness, according to the present invention.

FIG. 2 is a block diagram illustrating a system for analyzing medical facility's emergency preparedness, according to the present invention.

FIG. 3 is a block diagram illustrating some components of a hospital system.

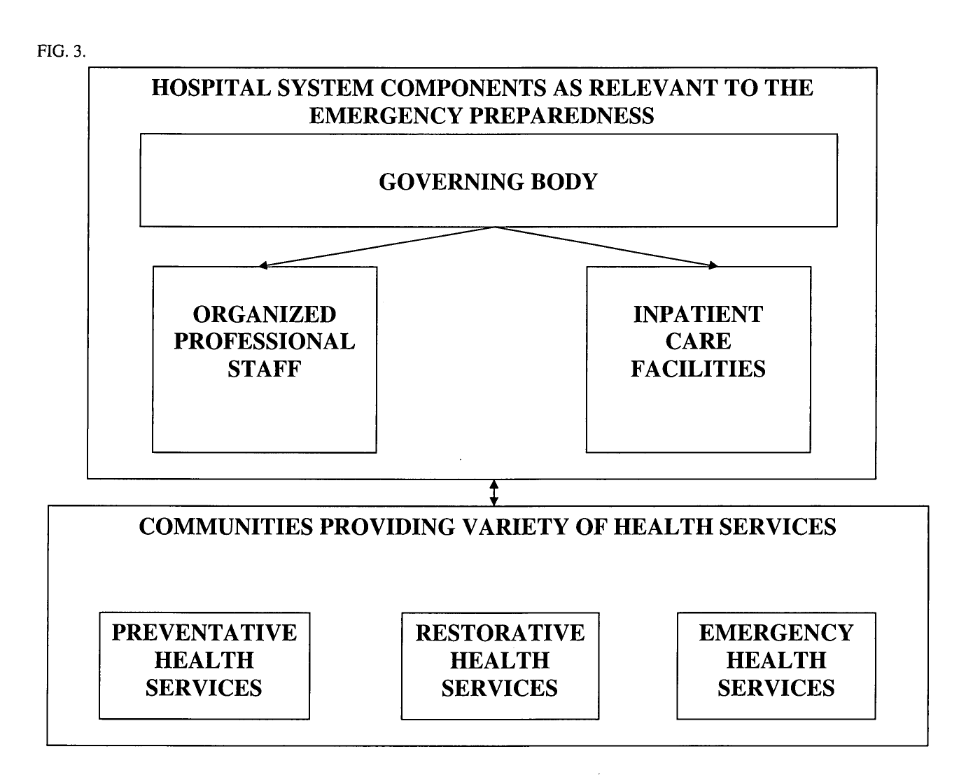

FIG. 4 is a block diagram illustrating some components of an ambulatory medical facility system.

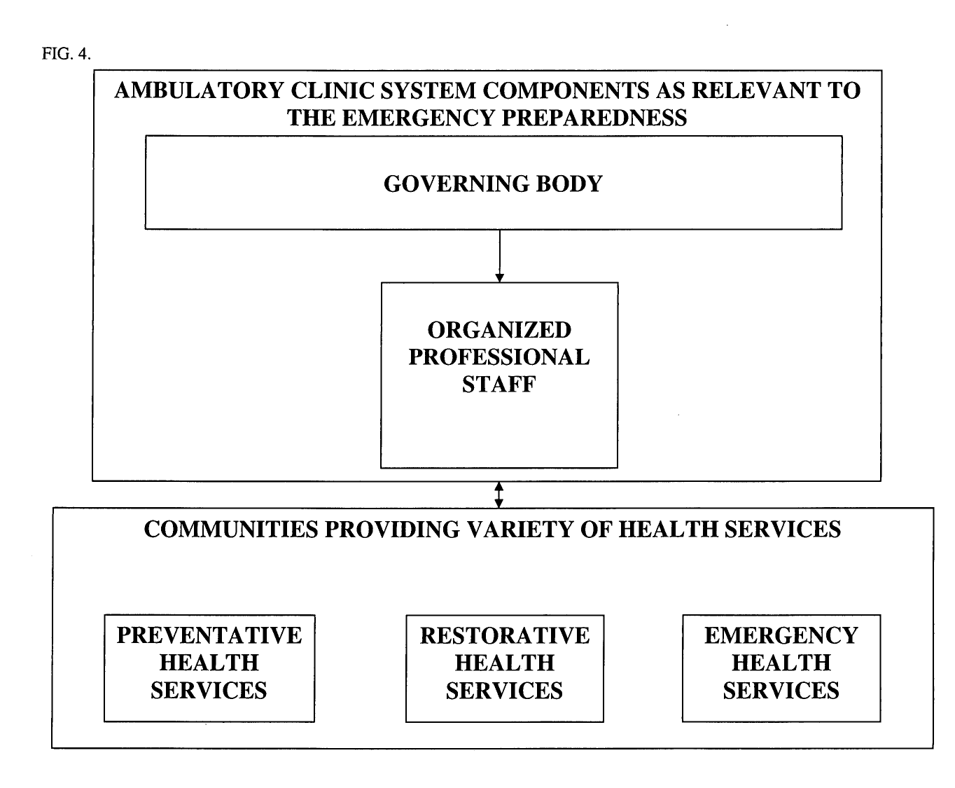

### DETAILED DESCRIPTION OF THE INVENTION

The present invention relates to emergency preparedness procedures and improvements thereof for medical facilities. The medical facilities can be hospitals, ambulatory clinics, and other stationary or transitory medical organizations. Because medical facilities are providing necessary health care to the population, such facilities have adequate emergency preparedness procedures in place. Further, these facilities can strive to improve their emergency preparedness. The reason for this is that many of the disasters, even though sometimes predictable (e.g., earthquakes, tornados, etc.), have unpredictable consequences. Thus, by having these procedures in place, the medical facilities are prepared for the unexpected disasters and any unexpected consequences.

Different disasters' consequences are dealt with differently. Most of the medical facilities have some type of emergency contingency plans. However, these plans are almost always limited in nature and not up to date with levels of magnitude of destruction, human casualties, and aftermath effects. The present invention provides a system and method for improving and updating the emergency preparedness procedures in a logical, efficient and cost-effective manner.

The present invention is a hospital and clinic emergency preparedness optimization system (hereinafter, the “HCEPOS”). The HCEPOS involves a process and a system that assesses a medical facility's emergency preparedness procedures and proposes ways to improve on the existing procedures. The medical facility can be a hospital, an ambulatory clinic, or any other medical organization.

In an embodiment, the HCEPOS determines the extent to which a medical facility has attained its stated objectives in preparing for, responding to and recovering from a disaster or an emergency situation resulting in mass casualties or damage and reduced operating capability of the facility. Once the HCEPOS is completed, the emergency planning procedures are either changed and/or improved upon. Also, the HCEPOS can propose revision of medical facility policies relating to emergency preparedness procedures. It further can advise adjustment of various medical facility's contracts, as well as, training programs and procedures for medical facility's professional staff and personnel. Further, as a result of the HCEPOS, the medical facility is better prepared to respond effectively in an emergency situation.

The HCEPOS is implemented when a medical facility commits itself to improvements in emergency management planning and procedures. The medical facility's executive staff then conducts strategic planning sessions. The sessions occur at regular intervals and define the medical facility's priorities, missions and visions. The sessions further identify a need for improvement in medical facility's emergency management and planning programs. Further, the sessions are designed to determine whether a validated system should be created and implemented to achieve the desired improvements in the emergency management and planning programs and procedures.

Once all of the above are identified, the medical facility requests that a HCEPOS team visit the facility for a preliminary analysis and observation. The HCEPOS team has various areas of medical emergency expertise and is capable of providing advice for development of medical emergency procedures and planning. In an embodiment, the preliminary visit and observation occurs over a 2-5 day period. A length of the preliminary visit and observation is determined by the size of the medical facility, the number of daily patient visits, the trauma designation level of the facility, and others. The size of the medical facility can be determined based on the number of patients currently at the medical facility, number of professional staff, number of non-professional staff, square footage of the facility, and/or other factors. The number of daily patient visits is determined based on the number of individuals or groups of individuals contacting the medical facility for treatment (whether preventative, restorative, or emergency treatment). The trauma designation level depends on the location, severity of injuries, medical specialty of the facility, and other factors. As can be understood by one having ordinary skill in the relevant art, the number of days that the HCEPOS team spends at the medical facility during the preliminary visit is not limited to 2-5 days. Further, the determination of the number of days to spend at the facility is not limited to the above factors.

After the preliminary visit is scheduled, the HCEPOS team and the medical facility's decision-making personnel, including facility's leadership, develop a schedule for the visit. In an embodiment, the schedule is based on a maximum availability of the medical facility professional and non-professional staff, scheduled emergency management plan drills, community activities, and/or availability of the HCEPOS team tailored to the facility's individual needs.

After the preliminary visit is scheduled and conducted, the HCEPOS team forwards a self-assessment tool to the medical facility. If the medical facility is a hospital, then the HCEPOS team forwards a hospital emergency analysis tool (hereinafter, the “HEAT”). However, if the medical facility is an ambulatory clinic, the HCEPOS team forwards an analysis tool for ambulatory care (hereinafter, the “ATAC”). Other types of medical organizations receive similar types of self-assessment tools.

The HCEPOS team provides instructions for completing the self-assessment tool. Further, the HCEPOS team allows ample time for the medical facility to thoroughly and accurately complete the self-assessment tool. For the self-assessment tool to effectively provide advice on improvements in emergency planning and procedure, the medical facility should take special care in answering all questions proposed in the tool. The tool's questions are directed to various departments within medical facility. Thus, it is forwarded to all responsible personnel within these departments. In an embodiment, the HCEPOS team allows the medical facility approximately 4-6 weeks to complete the self-assessment tool. As can be understood by one having ordinary skill in the relevant art, this time frame can be shortened or extended. This depends on various factors stated above. Upon completion of the self-assessment tool and before second HCEPOS visit, the completed tool is forwarded to the HCEPOS.

In one embodiment, the self-assessment tool is represented by the HEAT. The HEAT is based on medical facilities' research, the HCEPOS team's extensive emergency preparedness experience, current health care standards, and other factors. The HEAT is a structured evaluation tool that examines critical aspects of planning, process, structure, and outcome of the medical facility's emergency management status.

An exemplary embodiment of the HEAT is attached in Appendix A. The HEAT shown in Appendix A is specific to federal and military medical facilities. Appendix C illustrates a civilian embodiment of the HEAT. As can be understood by one having ordinary skill in the relevant art, the HEAT is not limited to the federal or military medical facilities.

The exemplary embodiment of the HEAT is subdivided into three main parts. The parts are: hospital profile, analysis of critical preparedness factors, and military treatment facility readiness. Each part has sections with relevant sub-sections. The section represent a broad subject matter and sub-sections include specific questions relating to the broad subject matter of the section.

The hospital profile part includes sections relevant to hospital staffing; branch clinics and staffing; current patient capacity; other hospital capacities; emergency management planning; safety, fire and security; logistics and facilities; and military treatment facility readiness. As can be understood by one having ordinary skill in the relevant art, the HEAT's first part can be tailored to other medical facilities, which are not associated with the military or federal government.

The analysis of critical preparedness factors part includes sections dealing with leadership and governance; emergency management planning; clinical operations; safety, fire, and security; logistics and facilities; communications, warning, and notification; public information, media relations, and risk communications; and, performance improvement and quality. Each of these sections are characterized by sub-sections, which request more detailed information with respect to a particular subject matter. For example, logistics and facilities section includes questions with regard to supplies, food services, emergency power, water supply, medical gasses, ventilation, fuel, and waste disposal.

The military treatment facility readiness part includes sections relating to National Disaster Medical System/Federal Coordinating Center activities; commander/commanding officer (or Chief Executive Officer) authority in an emergency; U.S. Department of Defense Integrated Conus Medical Operations Plan (ICMOP) preparedness; emergency program manager; respiratory protection equipment status; readiness status; immunization status; and readiness training status. As can be understood by one having ordinary skill in the relevant art, the questions in this part can be substituted with others that are relevant to a specific medical facility.

Each section and/or sub-section contains a single question or a series of questions. Each question can ask to provide an affirmative answer or an explanation.

In another embodiment, the analysis tool for ambulatory care is used. The ATAC is used for ambulatory care clinics and includes analysis of the HEAT factors, but it does not examine inpatient care capacities and other capacities specific to hospitals. An exemplary embodiment of ATAC is attached in Appendix B. As stated above, the ATAC is similar to HEAT, but does not include aspects specific to non-ambulatory medical facilities.

Based on the preliminary visit and analysis of the observations taken during the visit, the HCEPOS selects a multi-disciplinary team of experts for a main visit to the medical facility. The team includes at least one highly experienced individual having specific qualifications for various aspects of emergency preparedness and planning procedures. Further, the team is specifically trained in analyzing medical facility's factors used by the HCEPOS. In an embodiment, the team can include the following individuals:
Emergency medicine physician;
Disaster medicine physician;
Emergency nurses;
Health care executive;
Emergency medical services professional;
Antiterrorism/law enforcement;
Facilities engineer; and
Critical incident stress management specialist.

As can be understood by one having ordinary skill in the relevant art, the above list is not limited to these professionals. As such, depending on the medical facilities, some professionals can be removed or added to the list.

The HCEPOS team reviews the completed self-assessment tool. As stated above, the tool can be HEAT, ATAC, or other tool. For the purposes of discussion, the self-assessment tool will be referred to as HEAT/ATAC tool. The team reviews and analyzes the entire HEAT/ATAC tool and then concentrates on specific areas. The areas of concentration can be particular to the specializations of each team member. The HCEPOS team then identifies areas of strength and vulnerability within the medical facility.

Along with the review and analysis of the HEAT/ATAC tool, the HCEPOS team contacts the medical facility to request documents and other materials on emergency planning and procedures for analysis and review. These documents provide the team with critical information regarding the medical facility's emergency preparedness and response infrastructure. In an embodiment, the documents that are reviewed and analyzed by the HCEPOS team can include the following:
Organization strategic plan;
Policies and procedures manual;
Organizational diagram;
Disaster/emergency management plan;
Memoranda of understanding/agreement with community emergency response/fire/law enforcement agencies, vendors, services and other entities involved in emergency response;
After action reports from prior emergency management response exercises (the after action reports are described below), drills and analysis;
Hazard vulnerability analysis reports; and
Emergency management committee mission, purpose, and meeting minutes.

The above list is not all inclusive. Depending on the medical facility, this list can be adjusted appropriately.

To prepare for the main visit to the medical facility, the HCEPOS team requests that the facility identify its primary point(s) of contact to negotiate main visit's details. The medical facility's point of contact receives a request to schedule interviews with other medical facility's personnel. In an embodiment, the medical facility personnel to be interviewed includes the following individuals:
Chief executive officer;
Chief operating officer;
Chief nursing officer/senior nurse executive;
Disaster/emergency preparedness team;
Emergency department director;
Emergency department attending physicians;
Emergency department nurses;
Ambulatory care clinic directors;
Infectious disease physician;
Infection control practitioners;
Epidemiologic surveillance professionals;
Pharmacy department director;
Laboratory department director;
Microbiology director;
Blood bank director;
Critical care unit director(s);
Operating room director;
Post anesthesia care unit director;
Radiology department director;
Behavioral health director;
Critical incident stress management team director;
Clergy/pastoral care services;
Dietary/food services director;
Security director;
Safety manager;
Mortuary services director;
Facility engineer(s);
Facility maintenance team;
Communications/public affairs director;
Registration/clerical director; and
Volunteer director.

As can be understood by one having ordinary skill in the relevant art, the above list is not exclusive. This list can be modified according to the medical facility and its needs.

Before the main visit, the HCEPOS team provides some informational and educational materials about itself and/or emergency preparedness to the medical facility's executive personnel, including chief executive officer, primary points of contact and/or staff. The material educates the medical facility's staff about purposes and goals of the HCEPOS team main visit. The material explains to the personnel that the HCEPOS team will be looking at the facility to enhance its emergency preparedness capacity. Further, the materials indicate that the HCEPOS team will make recommendations and suggestions based on at least face-to-face interviews with the medical facility's personnel, its observations during the main visit, and other criteria.

During the HCEPOS team's main visit, it conducts an onsite analysis of the medical facility. The HCEPOS team undertakes detailed analysis process assisted. It is escorted through medical facility by the facility's personnel. The team also conducts interviews, reviews documents, and examines physical facilities. The analysis is guided by the questions and proposed answers in the HEAT/ATAC tool. The questions and proposed answers are referred to as critical preparedness factors and sub-factors.

Further, the HCEPOS team, through face-to-face interviews with medical facility's personnel, gathers data to determine presence or absence of each critical preparedness factor and/or sub-factor. Following the main visit to the medical facility, the HCEPOS team generates a report summarizing its findings. Specifically, each expert on the HCEPOS team reports on his/her own findings and conclusions. All findings and conclusions by members of the HCEPOS team are integrated into an after action report (hereinafter, the “AAR”). The AAR contains recommendations for changes to the existing emergency preparedness planning and procedures. These recommendations are based on assessment of presence or absence of critical preparedness factors and/or sub-factors.

In an embodiment, the AAR includes a scorecard that reflects a score between 1 and 100. This score represents a benchmark of the medical facility's emergency preparedness status at one point in time. The score can be used as a comparison point for assessment of successful implementation of changes to address vulnerabilities and to compare the facility's preparedness posture with other like-size facilities.

In an embodiment, the score is determined based on the HEAT/ATAC tool questions. The HEAT/ATAC tool includes 100 questions. Each question is assigned a point. Thus, a total of 100 points can be obtained. Further, to receive a point for a question that has several subparts all parts must be answered affirmatively. This means that a positive answer is given in response to a question of whether the medical facility has a specific procedure, plan, component or other factor relating to emergency preparedness implemented. If one of the subparts of the question is not answered or answered negatively, then no point is given for the question.

Based on the AAR and its findings, the medical facility develops a plan of action to address significant weaknesses. Further, the medical facility can also plan for re-assessment of HEAT/ATAC factors.

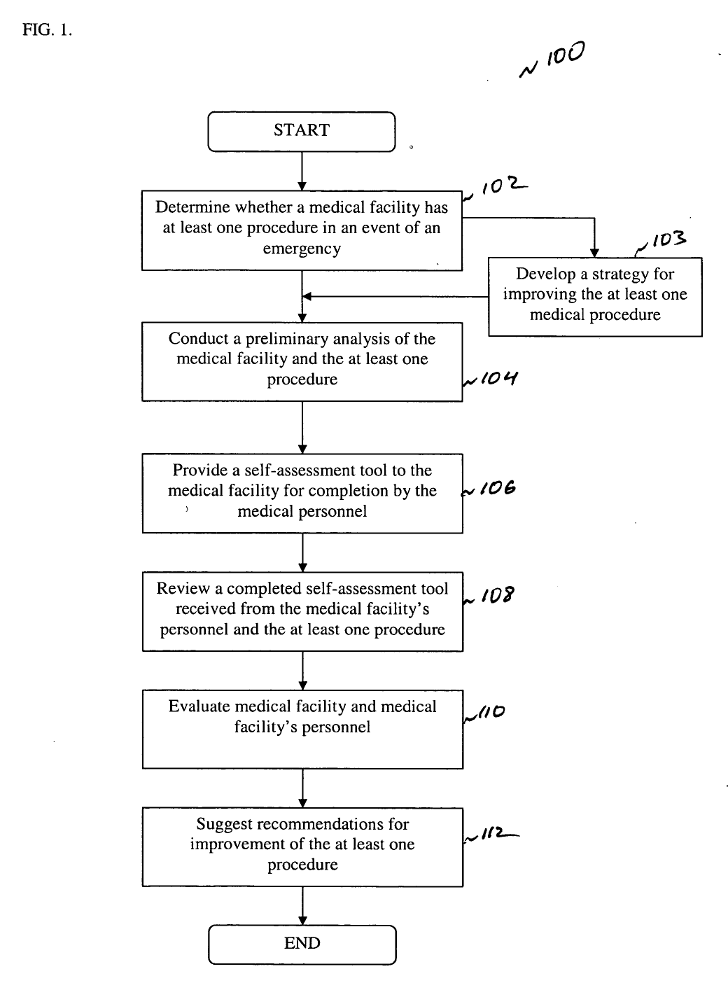

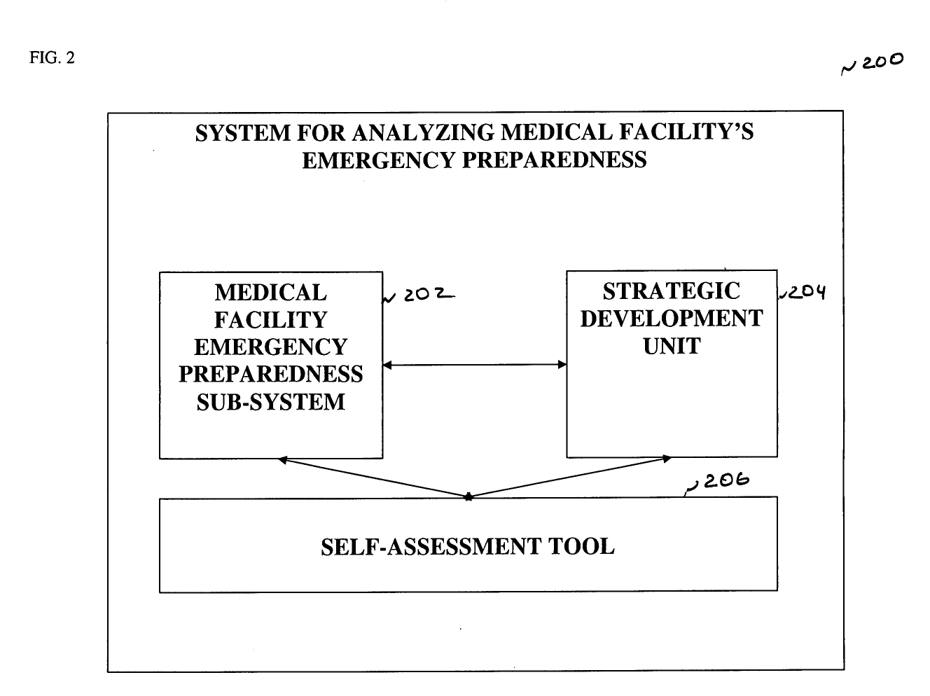

FIGS. 1 and 2 illustrate the system and method for improvement of emergency preparedness procedures, according to the present invention. A method 100 for improvement of emergency preparedness procedures is described in FIG. 1. The method 100 is implemented with the hospital and clinic emergency preparedness optimization system, i.e., the HCEPOS. The processing in method 100 begins with step 102. In step 102, the method determines whether the medical facility has at least one procedure in an event of an emergency. This is further characterized by a development of a strategy for improving the above procedure, as shown in sub-step 103.

The method then proceeds to step 104, where a preliminary analysis of the medical facility is conducted. The emergency preparedness procedure is also analyzed. The processing then proceeds to step 106.

In step 106, a self-assessment tool is provided to the medical facility. It is further requested that the medical facility's personnel complete the self-assessment or HEAT/ATAC tool. As stated above, the self-assessment tool is developed based on a plurality of factors relating to operations and regulations of the medical facility. Further, it addresses at least one area of the medical facility's emergency preparedness. Then, the processing proceeds to step 108.

In step 108, the completed self-assessment tool is reviewed. The emergency preparedness procedure is also reviewed in light of the completed self-assessment tool, which is received from the medical facility.

Based on the review undertaken in step 108, in step 110, the medical facility and the medical facility's personnel are evaluated. Finally, in step 112, recommendations for the improvement of the emergency preparedness procedure are suggested.

FIG. 2 illustrates a system 200 for hospital and clinic emergency preparedness optimization. As described above, the system 200 includes a medical facility emergency preparedness sub-system 202. The sub-system 202 includes the HCEPOS team of experts that employs its skill, knowledge, and experience to analyze and determine whether the medical facility is in a need to improve its emergency preparedness planning and procedures. As described above, the HCEPOS team schedules visits to the medical facility, conducts interviews with the staff, evaluates current procedures and generates a report based on its analysis (or the AAR).

The system 200 further includes a strategic development unit 204. The unit 204 includes individuals and experts associated with the medical facility. These individuals and experts are able to make decisions, provide information to the HCEPOS team, and facilitate review and analysis of the facility's emergency preparedness planning and procedures.

Further, the system 200 includes a self-assessment or HEAT/ATAC tool 206. The tool 206 refers to the HEAT/ATAC tool described above.

All three components are tied together via an exchange of knowledge and information. As a result, the system 200 is able to generate a report containing recommendations for improvement of the medical facility's emergency preparedness planning and procedures.

Example embodiments of the methods and components of the present invention have been described herein. As noted elsewhere, these example embodiments have been described for illustrative purposes only, and are not limiting. Other embodiments are possible and are covered by the invention. Such embodiments will be apparent to persons skilled in the relevant art(s) based on the teachings contained herein. Thus, the breadth and scope of the present invention should not be limited by any of the above-described exemplary embodiments, but should be defined only in accordance with the following claims and their equivalents.

1. A method for analyzing medical facility's emergency preparedness, comprising the steps of:
determining whether the medical facility has at least one procedure in an event of an emergency;
if so, developing a strategy for improvement of the at least one procedure;
in response to said determining and developing steps, providing a self-assessment tool to the medical facility for completion by the medical facility's personnel;
said providing step further including developing the self-assessment tool based on a plurality of factors relating to operations and regulations of the medical facility and that addresses at least one area of the medical facility's emergency preparedness;
reviewing the self-assessment tool after completion from the medical facility's personnel and reviewing the at least one procedure;
evaluating the medical facility and the medical facility's personnel based on said reviewing step; and
suggesting recommendations for the improvement of the at least one procedure based on said evaluating step.

2. The method of claim 1, wherein said developing a strategy step further comprises a step of discussing the at least one procedure and the improvement thereof with the medical facility's executive personnel.

3. The method of claim 1, wherein the medical facility is a hospital.

4. The method of claim 1, wherein the medical facility is an ambulatory clinic.

5. The method of claim 1, further comprising scheduling a visit to the medical facility for observation; and
wherein said providing of the self-assessment tool is based on the observation.

6. The method of claim 5, wherein said scheduling step further comprises scheduling the visit for a length of time, wherein the length of time depends on medical facility factors selected from the group consisting of: a size of the medical facility, a number of patients in the medical facility, a size of personnel in the medical facility, and a trauma designation for the medical facility.

7. The method of claim 5, wherein said scheduling the visit further comprises identifying in advance of the visit at least one expert in emergency preparedness to be associated with at least one area of the medical facility's emergency preparedness.

8. The method of claim 1, wherein the self-assessment tool includes information about medical facility's capacities, leadership and governance, emergency management planning, clinical operations, safety, fire and security procedures, logistics, facilities, communications, warning and notification procedures, public information, media relations, risk communications, training, drills and exercise procedures, performance improvement and quality control procedures.

9. The method of claim 1, wherein said evaluating step further comprises:
examining the medical facility;
interviewing personnel at the medical facility;
discussing emergency preparedness with medical facility's executive personnel; and
reviewing medical facility's documents relating to emergency preparedness.

10. The method of claim 9, wherein said evaluating step further comprises performing said examining, interviewing, discussing, and reviewing steps based on the plurality of factors.

11. The method of claim 1, wherein said suggesting step further comprises compiling a report based on said evaluation step.

12. The method of claim 11, wherein the report further comprises a summary of medical facility's emergency preparedness' strengths and weaknesses and a score, wherein the score is a numerical assessment of the medical facility's emergency preparedness.

13. A system for analyzing medical facility's emergency preparedness, comprising:
a medical facility's emergency preparedness sub-system;
wherein said emergency preparedness sub-system is configured to respond to an emergency based on at least one emergency preparedness procedure;
a strategic development unit configured to improve said at least one emergency preparedness procedure;
wherein said strategic development unit is further configured to conduct a preliminary analysis of the medical facility and said at least one emergency preparedness procedure;
a self-assessment tool configured to assist said strategic development unit in analyzing the medical facility;
wherein said self-assessment tool is further configured to be completed by the medical facility's personnel and developed based on a plurality of factors relating to operations and regulations of the medical facility and addresses at least one area of the medical facility's emergency preparedness;
wherein said strategic development unit reviews and evaluates said completed self-assessment tool received from the medical facility's personnel and said at least one emergency preparedness procedure.

14. The system of claim 13, wherein said strategic development unit is further configured to discuss the at least one procedure and the improvement thereof with the medical facility's executive personnel.

15. The system of claim 14, wherein said strategic development unit is further configured to employ at least one expert in emergency preparedness to be associated with at least one area of concern within the medical facility.

16. The system of claim 15, wherein said expert analyzes the medical facility for problem areas in emergency preparedness.

17. The system of claim 13, wherein the medical facility is a hospital.

18. The system of claim 13, wherein the medical facility is an ambulatory field clinic.

19. The system of claim 13, wherein said self-assessment tool includes information about medical facility's capacities, leadership and governance, emergency management planning, clinical operations, safety, fire and security procedures, logistics, facilities, communications, warning and notification procedures, public information, media relations, risk communications, training, drills and exercise procedures, performance improvement and quality control procedures.

20. The system of claim 13, wherein said strategic development unit is further configured to:
examine the medical facility;
interview personnel at the medical facility;
discuss emergency preparedness with medical facility's executive personnel; and
review medical facility's documents relating to emergency preparedness based on the plurality of factors.

21. The method of claim 13, wherein said strategic development unit is configured to provide a summary of medical facility's emergency preparedness' strengths and weaknesses and a score, wherein the score is a numerical assessment of medical facility's emergency preparedness.

22. A method to evaluate emergency preparedness of a facility, comprising:
based on a schedule, visiting the facility with a team and making observations;
preparing a self-assessment tool based on the observations and forwarding same to appropriate personnel at the facility to complete;
requesting the facility to identify primary points of contact to negotiate scheduling of interviews with personnel of the facility during a further visit to the facility;
conducting the further visit to the facility with a multi-disciplinary team of experts that includes at least one experienced individual having specific qualifications for various aspects of emergency preparedness and planning procedures; the further visit including conducting of the scheduled interviews, reviewing information from the facility, examining physical structures at the facility; and
having the multi-disciplinary team of experts identify areas of strength and vulnerability within the facility based on their visiting of the facility, their review of the self-assessment tool after completion by the appropriate personnel at the facility; and their review of information on emergency planning and procedures from the facility.

23. A method of claim 22, wherein the preparing of the self-assessment tool is based on research of the facility, extensive emergency preparedness experience of the team, and current health care factors and is structured to examine critical aspects of planning, process, structure and outcome of emergency management status of the facility.

24. A method of claim 22, wherein the multi-disciplinary team includes individuals selected from a group consisting of emergency medicine physicians, disaster medicine physicians, emergency nurses, healthcare executives, emergency medical services professionals, antiterrorism/law enforcement personnel, facilities engineers, and critical incident stress management specialists.

25. A method of claim 22, wherein the multi-disciplinary team provides the points of contact with material to educate the personnel scheduled to be interviewed about purposes of goals of the further visit with respect to enhancing emergency preparedness capacity.

26. A method of claim 22, further comprising having the multi-disciplinary team generate a report summarizing findings.

27. A method of claim 26, further comprising integrating the findings into an action report to contain recommendations for changes to existing emergency preparedness planning and procedures based on assessments of presence or absence of critical preparedness at the facility.

28. A method of claim 27, wherein the action report includes a scorecard whose scores represent a benchmark of the emergency preparedness status of the facility at one point in time.

29. A product useful to evaluate emergency preparedness of a facility, comprising:
an analysis tool for ambulatory care having queries to prompt responses with respect to facility profile, critical preparedness and facility readiness.

30. A product of claim 29, wherein the queries to prompt responses with respect to facility profile are selected from a group consisting of existing emergency management planning, existing safety fire and security, existing logistics and facilities, existing treatment readiness.

31. A product of claim 30, wherein the queries to prompt responses pertaining to emergency management planning are selected from a group consisting of patient capacity at the facility, patient volume threshold that triggers use of triage, patient isolation capacity, patient decontamination capacity.

32. A product of claim 30, wherein the queries to prompt responses pertaining to safety, fire and security are selected from a group consisting of number of drills conducted, emergency power duration and emergency power generation, identification of source of water supply and alternate water supply sources, identification of who tests water and frequency of water testing and to whom results are reported to, identification of fuel availability at the facility.

33. A product of claim 30, wherein the queries to prompt responses pertaining to treatment readiness are selected from a group consisting of respiratory protection equipment status available to personnel at the facility, immunization status of personnel at the facility, readiness training status of personnel at the facility.

34. A product of claim 29, wherein the queries to prompt responses with respect to critical preparedness are selected from a group consisting of leadership and governance, emergency management planning, clinical operations, logistics and facilities, communications, warning and notification, public information, media relations and risk communications, training, drills and exercise, performance improvement and quality,

35. A product of claim 34, wherein the queries to prompt responses with respect to leadership and governance are selected from a group consisting of leadership succession and continuity of operations, incident command systems, emergency operations center/command post, mutual aid agreements, emergency management/disaster preparedness committee.

36. A product of claim 34, wherein the queries to prompt responses with respect to emergency management planning are selected from a group consisting of emergency management plan, alternate care site, patient transportation, volunteer management.

37. A product of claim 34, wherein the queries to prompt responses with respect to clinical operations are selected from a group consisting of emergency medical services, emergency capacity, patient triage, patient tracking, patient isolation capacity, staff protection, patient decontamination, disease surveillance, radiation exposure, critical incident stress management, pharmacy services, facility-wide immunization and facility-wide chemophrophylaxis, fatality management, evidence collection and preservation.

38. A product of claim 34, wherein the queries to prompt responses with respect to logistics and facilities are selected from a group consisting of supplies to effectively respond to a mass casualty event, food services, emergency power, water supply, medical gasses, ventilation, fuel, waste disposal.

39. A product useful to evaluate emergency preparedness of a facility, comprising:
an analysis tool for a hospital facility having queries to prompt responses with respect to facility profile, critical preparedness and facility readiness.

40. A product of claim 39, wherein the queries to prompt responses with respect to facility profile are selected from a group consisting of patient care capacity, hospital capacities, existing emergency management planning, safety, fire and security existing logistics and facilities, existing treatment readiness.

41. A product of claim 40, wherein the queries to prompt responses pertaining to emergency management planning are selected from a group consisting of patient capacity at the facility, patient volume threshold that triggers use of triage, patient isolation capacity, patient decontamination capacity.

42. A product of claim 40, wherein the queries to prompt responses pertaining to safety, fire and security are selected from a group consisting of number of drills conducted, emergency power duration and emergency power generation, identification of source of water supply and alternate water supply sources, identification of who tests water and frequency of water testing and to whom results are reported to, identification of fuel availability at the facility.

43. A product of claim 40, wherein the queries to prompt responses pertaining to treatment readiness are selected from a group consisting of respiratory protection equipment status available to personnel at the facility, immunization status of personnel at the facility, readiness training status of personnel at the facility.

44. A product of claim 39, wherein the queries to prompt responses with respect to critical preparedness are selected from a group consisting of leadership and governance, emergency management planning, clinical operations, logistics and facilities, communications, warning and notification, public information, media relations and risk communications, training, drills and exercise, performance improvement and quality,

45. A product of claim 44, wherein the queries to prompt responses with respect to leadership and governance are selected from a group consisting of leadership succession and continuity of operations, incident command systems, emergency operations center/command post, mutual aid agreements, emergency management/disaster preparedness committee.

46. A product of claim 44, wherein the queries to prompt responses with respect to emergency management planning are selected from a group consisting of emergency management plan, alternate care site, patient transportation, volunteer management.

47. A product of claim 44, wherein the queries to prompt responses with respect to clinical operations are selected from a group consisting of emergency medical services, emergency capacity, patient triage, patient tracking, patient isolation capacity, staff protection, patient decontamination, disease surveillance, radiation exposure, critical incident stress management, pharmacy services, mass immunization and mass chemophrophylaxis, fatality management, evidence collection and preservation.

48. A product of claim 44, wherein the queries to prompt responses with respect to logistics and facilities are selected from a group consisting of supplies to effectively respond to a mass casualty event, food services, emergency power, water supply, medical gasses, ventilation, fuel, waste disposal.
